(19) United States
(12) Patent Application Publication
(10) Pub. No.: US 2013/0041592 A1
(43) Pub. Date: Feb. 14, 2013

(54) Method And System Using Computer Simulation For The Quantitative Analysis Of Glycan Biosynthesis

(71) Applicant: University Of Georgia Research Foundation, Inc., Athens, GA (US)

(72) Inventors: William S. YORK, Watkinsville, GA (US); John A. MILLER, Bishop, GA (US); Jun HAN, Athens, GA (US); Krzysztof J. KOCHUT, Athens, GA (US); Lance WELLS, Athens, GA (US)

(73) Assignee: University Of Georgia Research Foundation, Inc., Athens, GA (US)

(21) Appl. No.: 13/628,611

(22) Filed: Sep. 27, 2012

Related U.S. Application Data
(63) Continuation of application No. PCT/US2011/031022, filed on Apr. 1, 2011.
(60) Provisional application No. 61/320,228, filed on Apr. 1, 2010.

(51) Int. Cl. G06F 19/00; G06F 17/14

(52) U.S. Cl. 702/19

(57) ABSTRACT

This invention provides a quantitative analysis of glycan biosynthesis along meta pathways using computer simulation for comparing a computer generated spectrum to experimental data to quantitatively track the biosynthesis. Computer simulating the mass spectra of isotopic detection of aminosugars with glutamine experiments allows modeling the glycan biosynthesis over time, via changes in the ¹⁴N and ¹⁵N isotope abundance levels, to estimate the relative abundance of molecules involved in glycan biosynthesis, from experimental mass spectra. Gradient search optimization is used to maximize the coefficient of determination between the experimental spectrum and the simulated spectrum. These relative abundances are then fed into a pathway simulation model to analyze glycan biosynthesis. Simulating a mass spectrum allows reconfirming the identification, quantifying the isotopic configurations and obtaining the relative abundance of each as samples are taken at periodic intervals, which is then organized to allow tracking the changes in abundance levels over time.

### CLAIM OF PRIORITY AND GRANT SUPPORT

The present invention is a continuation of PCT International Patent Application no. PCT/US2011/31022 filed in the United States Patent and Trademark Office on Apr. 1, 2011, which claims priority in U.S. provisional patent application Ser. No. 61/320,228 filed Apr. 1, 2010, the entire contents of which are incorporated by reference entirely herein.

This invention was made with Government support under Grant no. NIH/NCRR P41RR018502, awarded by the National Institutes of Health. Consequently, the U.S. Government has certain rights in this invention.

### TECHNICAL FIELD

This invention relates to methods and systems for the quantitative analysis of glycan biosynthesis, and more particularly, to using a computer simulation in comparison to experimental data to quantitatively track the biosynthetic process.

### BACKGROUND OF THE INVENTION

Systems biology studies the interactions between components within a system (e.g., a cell) and how these interactions affect the behavior of the whole system. Although there have been several papers on the topic, the lack of a method and system for obtaining experimental time-series data which quantify the system's properties versus time hinders research in this area.

Although there have been studies examining the systems biology of glycan biosynthesis (Raman et al. 2005, Ref 21), reliable simulations are difficult to achieve. A glycan may be defined as a carbohydrate (saccharide) consisting of at least two residues (simple sugars). Glycan biosynthesis can be modeled as biochemical pathways using, for example systems of differential equations (Heinrich and Schuster 1998, Ref. 10), Petri Nets (Reddy et al. 1993, Ref. 22) or qualitatively domain ontologies (Silver et al. 2009, Ref 24). Even though the reactions in a pathway along with their substrates, enzymes and product may be known reasonably well, few rate constants are known and estimation of concentration levels is very challenging. On top of all these difficulties is a lack of reliable time-series data for model calibration.

Estimating the relative abundance of molecules involved in glycan biosynthesis from experimental mass spectra collected from different time points is challenging. One approach discussed herein utilizes gradient search optimization to maximize the correlation coefficient relating an experimental spectrum and a simulated spectrum. The relative abundances obtained by such analysis can be used to parameterize a pathway simulation model for glycan biosynthesis.

Mass spectrometry experiments often focus on ions corresponding to a few molecules whose abundances are of interest. Ion clusters that are identified by correspondence of their mass with the mass of an interesting molecule can be further characterized by analyzing their spectral signatures, based on the ratios of the isotopes of hydrogen (H), carbon (C), nitrogen (N) and oxygen (O). Molecules with the same chemical formula/collection of atoms are called isomers and those with the same numbers for each isotope are referred to as isotopologues. Each isotopologue can consist of several isotopomers, which differ only in the positions of the various isotopes.

Isotopic Detection of Aminosugars with Glutamine (hereafter referred to as “IDAWG™”) is a technique that introduces heavy nitrogen (¹⁵N) at a high level of purity (>95%) to cell samples (Orlando et al. 2009, Ref. 19). When such ¹⁵N-enriched cells are incubated with natural-abundance precursors, the ratio of ¹⁴N to ¹⁵N in the amino sugars in the sample will increase over time, approaching the natural abundance ratio. The reasons for this increase are twofold: First, a combination of reactions that remove or add sugar residues to the glycan molecule can replace an ¹⁵N atom with an ¹⁴N atom. Second, completely new glycan molecules containing mainly ¹⁴N atoms can be synthesized. Thus the increase can be due to molecular remodeling as well as new synthesis. The converse experiment, where the incorporation of ¹⁵N into natural abundance molecules is monitored, provides similar, but complementary information.

As an example, consider a sodiated (adds Na^{|}) ion of reduced and permethylated glycan with the glycosyl composition (Gal)₁(GalNAc)₁(NeuNAc)₂. The unique elemental composition of this ion, C₅₅H₉₉N₃O₂₇Na⁺ includes three nitrogen atoms. Any particular occurrence of such a molecule may have 0, 1, 2 or 3 ¹⁴N atoms. The remaining 3, 2, 1, or 0 nitrogen atoms are ¹⁴N isotopes. Each of these four isotopologues has its own distinct spectral signature.

The Complex Carbohydrates Research Center (CCRC) at the University of Georgia has been collecting time-series data for mass spectrometry (MS) experiments designed to study glycan biosynthetic pathways. In particular, IDAWG™ experiments incorporate heavy nitrogen (¹⁵N) into N-linked and O-linked glycans, which brings additional information to help explore these biosynthetic pathways. Simulating the mass spectra generated by IDAWG™ experiments allows the distribution of ¹⁴N and ¹⁵N isotopes in glycans to be monitored over time, providing fundamental information required for realistic modeling of glycan biosynthesis and remodeling.

Simulating such a spectrum validates the identification of molecules represented in the spectrum and provides a means to determine the relative abundances of the various isotopologues in the sample. This information can then be organized into time-series data allowing tracking of the changes in the isotopic labeling pattern over time. These results can then be incorporated into dynamic glycan biosynthesis models that shed light on important biological processes.

In order to carry out the analysis, a substantial amount of time-series data was collected with a resolution up to every six hours and a duration of up to 36 hours. The data, in the form of mass spectra, i.e., ion abundances versus mass-to-charge (m/z) values, are stored in a database. Identification of molecules giving rise to ions in the spectra is challenging in many cases, since different molecules can give rise to ions that are superimposed in the spectrum because they have the same mass to charge (m/z) ratio. However, by measuring the m/z and abundances of diagnostic molecular fragments, multiple mass spectrometry (i.e., MSⁿ) can often provide high confidence molecular assignments of overlapping ion clusters.

Simulation of the isotopologue patterns in an ion cluster is based on parameters that describe the populations of ions arising from molecules that contain various combinations of atoms from heavy and/or light precursors. Optimization techniques can be used to adjust these parameters to maximize the correspondence of the simulated and laboratory spectra, providing a quantitative analysis of the spectral data that reveals the specific contributions of heavy and light precursors to the molecules of interest.

### SUMMARY OF THE INVENTION

One object of the present invention is to provide a method and system using computer simulation for the quantitative analysis of glycan biosynthesis.

Another object is to provide a method and system using computer simulation for the quantitative analysis of glycan biosynthesis that utilizes IDAWG™ data to generate parameter values required for set-up and quantitative validation of computerized models of glycan biosynthesis.

These and other objects of the present invention are achieved by a method for quantitatively tracking glycan biosynthesis comprising growing a target biological material in the presence of an isotope labeled glutamine, the biological material thereby producing labeled glycans, preparing a plurality of parameterized spectral patterns of glycans using a computer simulation program by calculating simulated spectral signatures for every isotope analog thereof, performing a spectral analysis of each isotope analog and obtaining actual spectral patterns therefrom, comparing the actual spectral patterns to the simulated spectral patterns and adjusting the simulated spectra for improving the accuracy thereof. The method then provides using labeled glutamine and performing a biosynthesis to produce labeled glycans, obtaining a sample and spectrally analyzing the sample at predetermined time intervals during the biosynthesis of labeled glycans, and, comparing the sample spectra to the computer simulated spectra and extracting quantitative data that is encoded in the spectral patterns of the sample spectra for each predetermined time interval.

Preferably, the data extracted includes the isotope composition of an ion cluster which generates the spectral pattern, with the data extracted being a distribution of metabolic precursor pools from which the glycans corresponding to the ion cluster were synthesized. In one embodiment, the computer simulation program calculates the simulated mass spectrum by identifying an elemental composition that corresponds to an ion cluster in the experimental spectrum, calculating the number of potentially labeled atoms from the elemental composition, generating a list of isotopic compositions for possible isotopologues, and, for each isotopologue, calculating an array of [mass, probability] for the isotopologue, using this array to simulate a sub-spectrum corresponding to the isotopologue, and generating a linear combination of these simulated spectra that closely matches the spectrum observed in the laboratory. The simulated spectrum is then parameterized by dividing the simulation parameters into two sets, experimental parameters and spectral parameters, and optimizing the parameters in groups, preferably using a Gradient Ascent method.

Another embodiment of the invention is directed to a computer based system for performing the method of the invention. In particular, a computer system for simulating spectral patterns for isotope labeled glycans for use in a quantitative tracking of glycan biosynthesis is provided which includes a database containing experimental spectral patterns of the isotope labeled glycans, a processor for identifying the elemental composition from the experimental spectrum patterns, calculating the number of labeled atoms from the elemental composition and generating a list of isotope compositions for all possible isotopologues, and for each isotopologue, calculating an array of [mass, probability] for the isotopologue, generating a linear combination of these simulated spectra that closely matches an experimental spectrum, parameterizing the simulated spectrum by dividing the simulation parameters into two sets, experimental parameters and spectral parameters, and optimizing the parameters in groups, preferably using a Gradient Ascent method.

In yet another embodiment of the invention, a method for the periodic isotope detection of aminosugars with glutamine and the quantitative analysis of the biosynthesis thereof comprising the steps of:

providing a computer system for simulating spectral patterns for isotope labeled glycans, the computer system having a database containing experimental spectral patterns of the isotope labeled glycans, and a processor for identifying the elemental composition from the experimental spectrum patterns, calculating the number of labeled atoms from the elemental composition and generating a list of elemental compositions for all possible isotopologues, and for each isotopologue, calculating an array of [mass, probability] for the isotopologue, generating a simulated spectrum for each isotopic analog, based on a concentration level, normalizing the simulated spectra, the computer system parameterizing the simulated spectrum by dividing the simulation parameters into two sets, experimental parameters and spectral parameters, optimizing the parameters in groups, and confirming the quantitative information that is encoded in the simulated spectral patterns;

obtaining a biological material and growing the biological material in the presence of isotope labeled glutamine, the biological material thereby producing labeled glycans in a biosynthesis,

performing periodic sampling during the biosynthesis of labeled glycans and performing a spectral analysis of the sampled labeled glycans for obtaining actual spectral patterns therefrom, and,

comparing the actual spectral patterns to the simulated spectral patterns and extracting quantitative information that is encoded in the spectral patterns for tracking the biosynthesis of the produced labeled glycans over time.

Thus, the methods and systems of the invention provide a unique and novel way to follow quantitatively glycan biosynthesis over time. Understanding glycoprotein biosynthesis is important to many biological phenomena, and should eventually lead to the development of new drugs and/or treatments that will help to control pathological processes involving carbohydrate-mediated interactions.

### BRIEF DESCRIPTION OF THE FIGURES

FIG. 1 shows a simplified pathway representing how (Gal)₁(GalNAc)₁(NeuNAc)₂ is synthesized in an IDAWG™ experiment.

FIG. 2 shows the process for developing the mass spectrum simulation.

FIG. 3 shows the pathway model of three reactions synthesizing (GalNAc)₁(Gal)₁(NeuAc)₂.

FIGS. 4a-4e show the simulated spectrum vs. experimental spectrum for (NeuNAc)₂(Gal)₁(GalNAc)₁ over time.

FIG. 5 shows the concentration levels of isotopologues of (NeuAc)₂(Gal)₁(GalNAc)₁ at five time points.

### DETAILED DESCRIPTION OF THE INVENTION

Mass spectrometry (MS) is “a microanalytical technique that can be used selectively to detect and determine the amount of a given analyte” (Watson and Sparkman 2007, Ref. 27). Besides the quantitation of analytes, MS “is also used to determine the elemental composition and some aspects of the molecular structure of an analyte” (Watson and Sparkman 2007, Ref 27). For its high sensitivity and fast speed, MS “has evolved to become an irreplaceable technique in the analysis of biologically related molecules” (Glish and Vachet 2003) (Ref. 8). A typical MS procedure involves generation of charged molecular ions and measurement of their mass-to-charge (m/z) ratios and relative abundance. The output data from the mass spectrometers, namely, mass spectra, can be represented as a plot of intensity vs. m/z value and stored in a file as a sequence of [m/z, intensity] pairs.

IDAWG Experiments

The development of the IDAWG™ technique (“Isotopic Detection of Aminosugars With Glutamine”) relates to the incorporation of differential mass tags into the glycans of cultured cells. In this method, culture media containing amide-¹⁵N-Gln is used to metabolically label cellular aminosugars with heavy nitrogen. (Orlando et al. 2009).

In IDAWG™ experiments, a “light” form (natural abundance ¹⁴N) and a “heavy” form (¹⁵N-enriched) of glutamine are used to prepare otherwise identical culture media. Natural abundance or ¹⁵N-enriched nitrogen from the glutamine is incorporated into all newly synthesized aminosugars. After a number of cell divisions, each instance of particular aminosugar is replaced by a family of isotopologues, which contains the identical elements in the elemental composition except that the number of ¹⁴N and ¹⁵N atoms do not correspond to natural abundance. If the number of nitrogen atoms is n, the number of isotopologue families for this elemental composition is (n+1). For an elemental composition of HₓC_{y}NₙO_{z}, the (n+1) families of isotopologues can be represented as HₓC_{y}(15N)ᵢ(14N)ⱼO_{z}, where i+j=n. For each family, the abundances of the isotopes of other elements in the composition, such as hydrogen, carbon and oxygen, remain the same as the occurrence in nature since no enriched sources of these elements are introduced in IDAWG™ experiments.

Consider a sodiated ion of reduced permethylated (Gal)₁(GalNAc)₁(NeuNAc)₂ as an example, its elemental composition is C₅₅H₉₉N₃O₂₇Na⁺. Because it contains three nitrogen atoms, the possible isotopologue families include the following:

C₅₅H₉₉¹⁵N₀¹⁴N₃O₂₇N^{|}, C₅₅H₉₉¹⁵N₁¹⁴N₂O₂₇Na^{|}, C₅₅H₉₉¹⁵N₂¹⁴N₁O₂₇Na^{|}, and C₅₅H₉₉¹⁵N₃¹⁴N₀O₂₇Na⁺.

For brevity, each of these sets of isotopologues is represented as a tuple of [¹⁵N, ¹⁴N] ∈ {[0, 3], [1, 2], [2, 1], [3, 0]} because the number of the other elements is identical, namely C₅₅H₉₉O₂₇Na⁻.

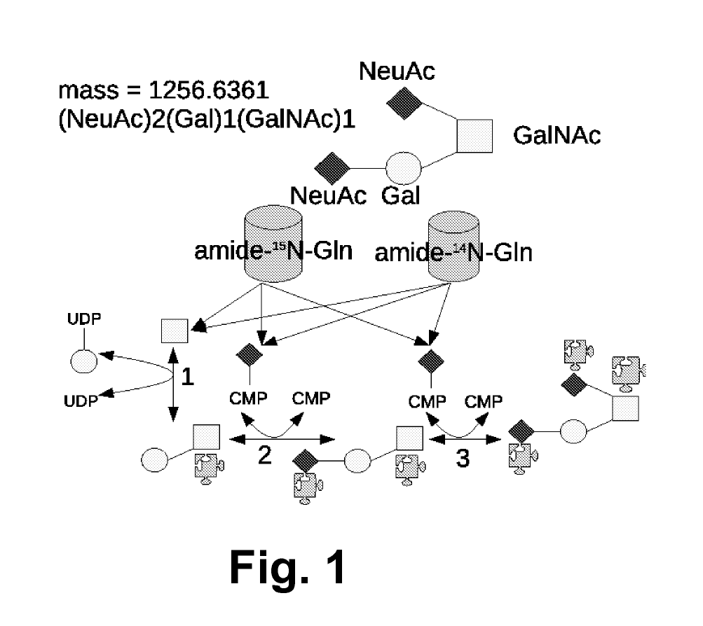

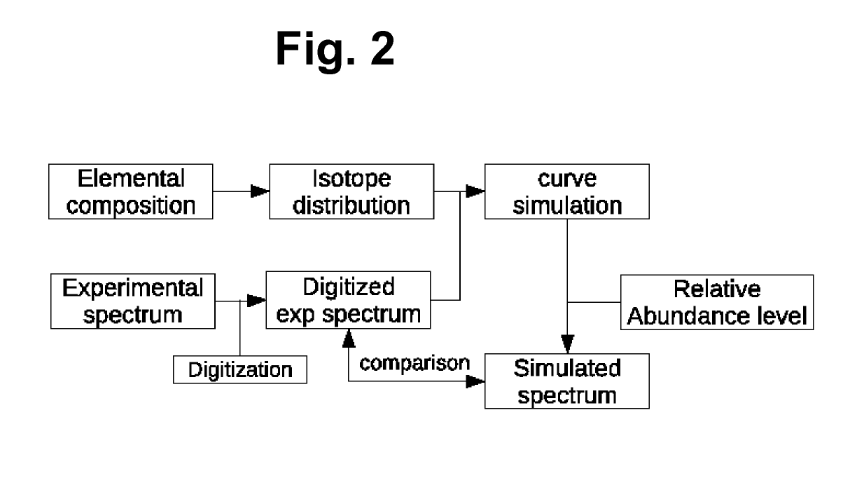

FIG. 1 shows a simplified pathway representing how (Gal)₁(GalNAc)₁(NeuNAc)₂ is synthesized in an IDAWG™ experiment. This pathway is described in: (i) the lab page of Dr. Kelley Moremen under the “GalNAc (mucin-type) core synthesis/branching” section (see http://www.ccrc.uga.edu/˜moremen/glycomics/) and (ii) O-Glycan biosynthesis pathway section of KEGG (Kyoto Encyclopedia of Genes and Genomes) (see REACTION R05908, R05913 and R05914 in http://www.genome.jp/kegg-bin/show_pathway?bta00512). The graphical format used to represent these structures is described in http://glycomics.scripps.edu/CFGnomenclature.pdf.

The sole nitrogen sources of experiments are amide-¹⁴N-Gln (light medium) or amide-¹⁵N-Gln (heavy medium) as indicated by the arrows starting from them. After three reactions, which are marked with 1, 2 and 3, occur following the controlled biosynthetic pathway, (Gal)₁(GalNAc)₁(NeuNAc)₂ is synthesized as the final product. Due to the existence of both light and heavy media, positions with puzzle mark in FIG. 1 will contain either ¹⁵N or ¹⁴N. Therefore, considering the combinations of numbers of ¹⁵N and ¹⁴N, four isotopologue families of (Gal)₁(GalNAc)₁(NeuNAc)₂, namely [0, 3], [1, 2], [2, 1] and [3, 0], will be generated during the biosynthesis process. Furthermore, for each isotopologue family with a fixed number of ¹⁴N and ¹⁵N, e.g. ¹⁵N₁¹⁴N₂, many different isotopomers exists, in part because ¹⁴N and ¹⁵N atoms may be present at the different positions, which are denoted by puzzle marks. These isotopomers have the same number of each isotopic atom but differing in their positions.

In FIG. 1, UDP (Uridine Diphosphate) and CMP (Cytosine Monophosphate), classified as sugar nucleotides, donate sugar residues to the growing glycan, as discussed more fully below. The cultures were grown in the media for a total of 36 hours and mass spectra were recorded using aliquots sampled at time points of Hr_{—}0, Hr_{—}6, Hr_{—}12, Hr_{—}24 and Hr_{—}36 for the subsequent simulation and modeling.

### Chemical Composition

Chemical composition can be represented as a residue composition or an elemental composition. In IDAWG™ experiments, the residue composition and the corresponding monoisotopic mass are in one-to-one mapping and stored in a pre-defined configuration file. The residue/elemental composition is identified by looking up monoisotopic mass (mass) in the configuration file, while mass is calculated from both charge state (z) and (m/z) value of the monoisotopic peak in the experimental spectrum via the formula m/z=mass/z. The monoisotopic peak, which corresponds to the isotopomer containing the most abundant isotopes for each element (all ¹H, ¹²_{C}, ¹⁴N, and ¹⁶O, etc.) is used to identify the elemental composition of each ion. The charge state (z) is an integer, typically in range of −5 to +5, that indicates the electrical charge of the molecular ion.

Mass spectrometers use an ionization process (e.g., electro-spray or UV light) to put a charge on molecules in order to accelerate them toward the detector. The value of the charge state is specified in the same configuration file as the mapping between residue compositions and masses, and the default is +1.

### Isotope Distribution

For a molecule containing n atoms, its population of isotopologues follows multinomial distribution. For each possible isotopologue, the mass and probability can be computed via Equation 1. For example, the oxygen element has three significantly populated (stable) isotopes in nature, namely, ¹⁶O, ¹⁸O and ¹⁷O. From the table of isotopes, the three isotopes' relative abundances are pᵢ=0.99762, P₂=0.00200 and p₃=0.00038 and their atomic masses are m₁=15.9949146, m₂=17.9991604 and m₃=16.9991315, respectively. (See http://www.matpack.de/Info/Nuclear/Nuclids/). Carbon, hydrogen and nitrogen each have two stable isotopes. By substituting xᵢ with the number of atoms of each isotope and mᵢ is the corresponding isotopic mass, the mass contributed to the isotopologue and probability (p(x₁, x₂, x₃) or probIso) that a particular molecule is that isotopologue can be calculated via Equation 1.

$$probIso = p ( {x}_{1} , {x}_{2} , … , {x}_{k} ) = \frac{n !}{\prod {x}_{i} !} \prod {p}_{i}^{{x}_{i}} \qquad Equation 1$$

where n is the number of atoms in the molecule such that Σxᵢ=n and xᵢ ∈ {0,1, . . . , n} is the number of atoms of each stable isotope in the isotopologue; mᵢ and pᵢ are obtained from the table of isotopes. Since the number of possible combinations is large, a probability threshold is used to limit the number of isotopomers calculated.

After an array of [probIso, massIso] pairs is calculated (one pair for each isotopologue that is consistent with the chemical formula), a segment of the mass spectrum [m/z vs. abundance] is simulated using an algorithm that uses a joint probability formula to generate Gaussian and/or Lorentzian line shapes as a function of m/z, based on the array [probIso, massIso].

Besides those elements with natural abundance isotopes, IDAWG™ experiments introduce ¹⁵N-enriched precursors into the cultivation media. The population of isotopologues in molecules that incorporate nitrogen from ¹⁵N-enriched precursors also follows a multinomial distribution. If the isotopic purity of ¹⁵N is purity, then the abundance of ¹⁴N in the enriched precursor is (1-purity). This is addressed computationally by defining “pseudoelements” that consist of isotopes in non-natural ratios. ¹⁵N-enriched nitrogen is defined as the pseudoelement Ñ. For example 98% ¹⁵N-enriched nitrogen consists of the same isotopes as N, except that 98% of the Ñ atoms are ¹⁵N and 2% of the Ñ atoms are ¹⁴N. In this way, the “pseudochemical” formula of an isotopically enriched precursor or a biomolecule that incorporates atoms from that precursor can be specified. That is, natural abundance glutamine has the chemical formula C₅H₁₀N₂O₃ while 98% amide-¹⁵N-enriched glutamine has the pseudochemical formula C₅H₁₀NO₃Ñ. Specification of such a formula allows the masses and populations of isotopologues for isotopically labeled molecules to be calculated using Equation 1. This also allows arrays describing the isotopologue populations and masses [probIso, massIso] of biomolecules (such as glycans) whose atoms are derived from both natural abundance and isotopically-enriched precursors to be calculated explicitly.

For example, a glycan that contains n nitrogen atoms can be represented as a combination of the following n+1 pseudochemical formulae: C_{c}HₕNₙOₒ, C_{c}HₕNₙ₋₁OₒÑ₁, . . . , C_{c}HₕOₒÑₙ, where c, h and o indicate the number of C, H and O atoms in the molecule. Each pseudochemical formula corresponds to a unique set of isotopologues. The experimental spectrum corresponds to a linear combination of these n+1 sets of isotopologues, and this combination can be described as a vector T=(t₀, t₁, . . . tₙ), where each number tⱼ represents the proportion of the molecules that contain j atoms of the pseudoelement Ñ.

Each tⱼ also describes the population of molecules that contain j nitrogen atoms from the enriched precursor pool and n−j nitrogen atoms from the natural abundance precursor pool Thus, the time-dependent evolution of T during cell growth provides key information regarding the metabolic fate of isotopically enriched precursors and thereby sheds light on the biochemical process that led to the formation of the glycan.

### Simulation of Spectral Peaks

The IDAWG™ experimental data may be recorded using an orbital trapping method (Hu et al. 2005, Ref. 11) and post-processed using a Fast Fourier Transform (FFT). The resulting spectral features have line shapes that are a combination of Lorentzian and Gaussian shapes, depending on the parameters used for data processing. The ratio of Gaussian to Lorentzian is thus a parameter that must be optimized for accurate spectral simulation. Furthermore, to obtain a high quality fit to the experimental peaks, some additional spectral parameters need to be considered for optimization.
Peak Width: the peak width (pw) of the mixed Gaussian and Lorentzian curve is related to the standard deviation (σ) of the curve's probability density function (pdf) as σ=0.4247×pw, which is given in section 9.2.3.3 of (Inczédy et al. 1998, Ref. 12).
Delta: Delta is the shifting parameter between the experimental and theoretical spectra. Due to errors in calibrating m/z for the experimental data, the m/z values for the experimental spectrum may be shifted slightly to the left or right side with regard to the theoretical mass value.
Normalization Threshold: When the experimental spectrum is generated in the mass spectrometer, very low intensity values are cut out (set to zero) by the instrument and rejected as noise. However, there is no noise in the theoretical simulation, so a normalization threshold is used to cut off the simulated spectrum in order to mimic the experimental data collection process.

In summary, using the array of [Prob, Mass] pairs for each isotopomer, the simulated spectral peaks as a combination of Lorentzian and Gaussian shapes is calculated by the computer processor using Equation 2.

$${f}_{L} ( i ) = {\prod }_{j} {Prob}_{j} \times \frac{1}{πσ [ 1 + {[ \frac{{Mass}_{j} - ( {mass}_{i} + delta )}{σ} ]}^{2} ]} \\ {f}_{G} ( i ) = {\prod }_{j} {Prob}_{j} \times \frac{1}{σ \sqrt{2 π}} {exp}^{- \frac{{[ {Mass}_{j} - ( {mass}_{i} + delta ) ]}^{2}}{2 {σ}^{2}}} \qquad Equation 2$$

where σ is calculated from the peak width of the mixed Gaussian and Lorentzian curve, both Prob and Mass with index j are theoretical mass and probability values in [Prob, Mass] array of each isotopologue, mass with index i is calculated by the computer processor from charge state and m/z value from experimental spectrum.

After both curves are simulated, the complete simulated spectrum for one isotopologue is computed via Equation 3.

simuSpecᵢ=r×f_{G}(i)+(1−r)×f_{L}(i) Equation 3

where simuSpec is an array of spectral data points with index i and r is the Gaussian fraction of the total.

Simulation of IDAWG™ Mass Spectrum

After the computer processor calculates simulated spectral signatures for every isotopologue in Equation 4, the complete simulated IDAWG™ mass spectrum is a weighted sum of sub-spectral signature from all the (n+1) isotopologues based on the concentration level of each, if the number of nitrogen atoms in the elemental composition is n.

In summary, the algorithm used by the computer for generating the simulated IDAWG™ mass spectrum is listed in Table 1.

TABLE 1
Simulation of IDAWG ™ Mass Spectrum

| | |
|---|---|
| 1. | identify the elemental composition from experimental spectrum |
| 2. | calculate the number of nitrogen atoms from the elemental |
| | composition |
| 3. | generate list of elemental compositions for possible isotopologues |
| 4. | FOR ALL ia ← isotopologue |

| | |
|---|---|
| 5. | calculate the array of [Prob, Mass] of ia |
| 6. | simulatedSpec ← simulateMassSpectrum(ia) |
| 7. | idawgSpec + = simulatedSpec × concentrationLevel(ia) |

| | |
|---|---|
| 8. | END FOR |
| 9. | normalize idawgSpec |
| 10. | RETURN idawgSpec |

### Simulation Optimization

In order to precisely simulate IDAWG™ mass spectra, several simulation parameters need to be adjusted.

This leads to a multi-dimensional optimization problem, in which the difference between the simulated and the experimental spectra should be minimized. The simulation parameters are divided into two sets:
Experiment Parameters: (i) isotopic purity of ¹⁵N, (ii) relative abundances of the (n+1) isotopologues
Spectral Parameters: (i) peak widths of Gaussian and Lorentzian shapes, respectively, (ii) fraction of Gaussian shape of the total, (iii) delta and (iv) normalization threshold

It is not feasible to perform an exhaustive search to find an optimal solution for the following reasons:

(i) there are (n+5) independent parameters where n is the number of nitrogen atoms, (ii) the search space is continuous, and (iii) the experimental data is high resolution with 4 to 5 significant digits.

The approach is to optimize the parameters via a Gradient Ascent method. It is difficult to perform a gradient search for all parameters at once, because the gradient of all parameters will often lead to divergence rather than to convergence. Therefore, parameters are grouped and optimized separately. The effects of noise in fitting the spectral parameters are minimized as these parameters are fitted using a small region of the monoisotopic peak within the complete experimental spectral window. Furthermore, using a small window makes optimization of the spectral parameters much faster. Then, fitting the experimental parameters such as the isotopic purity of ¹⁵N will also be faster, as the dimensionality of the problem is reduced and diversions from the optimal solution that occur as a result of inappropriately adjusting peak width and delta (which have relatively large effects and which have already been optimized) do not occur when the derivative purity (which has a small effect) is varied.

The Hr_{—}0 data of IDAWG™ experiments only contains the “heavy” ¹⁵N media, therefore the concentration levels of isotopologues are all 0s except for the one containing all ¹⁵N, which is 100%. Another tuple [pool_{—}1, pool_{—}2] in ([3, 0], [2, 1], [1, 2], [0, 3]) is defined here to indicate the number of nitrogen atoms in the ion that originate from the ¹⁵N-enriched and natural abundance glutamine pools, respectively. Thus, the tuple [3,0] corresponds to ions in which all three of the nitrogen atoms originate from the ¹⁵N-enriched glutamine precursor pool. (Please note that not all of the nitrogen in an ion composed of 100% [3, 0] is ¹⁵N, as the isotopic purity of the precursor pool is always less than 100%.) This tuple reflects the metabolic history of the ion while taking into account the isotopic purity of the precursor pool.

The two major modules in the optimization algorithm are the following:
Linear Least Squares Fitting:

The coefficient of determination (R) is used as a measure of how well the simulated spectrum fits the experimental spectrum. Using a correlation coefficient in comparing the goodness-of-fit of simulated spectrum was proposed in (MacCoss et al. 2003, Ref 17). After the simulated spectrum is generated, the intensity of both the simulated and experimental spectra are compared. If the pattern of both spectra matches well, the coefficient of determination is close to 1. The optimization result shows that the optimization algorithm reaches the expected outcome.
Gradient Ascent optimization: Gradient Ascent optimization (Fletcher and Powell 1963) (Ref. 5) is applied to search for a near optimal solution because the search space is continuous and multi-dimensional. The typical procedure of Gradient Ascent optimization is as follows: changing the parameters by a small Δ, calculating the gradient via

$$∇ f ( x ) = \frac{f ( x + Δ ) - f ( x - Δ )}{2 Δ} ,$$

where x is a vector of parameters, adjusting the value of parameter after each iteration by a small step to the direction that would most increase the fitness value. In order to handle constraints of parameter, penalty function is used by assigning penalty=min[0, value-lowerLimit]+min[0, upperLimit-value] when updating the parameter value. Line search is used to change step size adaptively for faster convergence. The Gradient Ascent routine utilized herein is shown in Table 2.

TABLE 2
Gradient Ascent Algorithm

| | |
|---|---|
| 1. | newF ← f(x₀), oldF ← −∞, maxF ← f(x₀) |
| 2. | WHILE \|∇f(x) ≧ δ\| |

| | |
|---|---|
| 3. | λ←1, oldF ← newF, x ← x₀ + λ |
| 4. | WHILE newF ≦ oldF |

| | |
|---|---|
| 5. | λ ← λ / 2, x ← x₀ + λ, newF ← f(x) |

| | |
|---|---|
| 6. | END WHILE |
| 7. | IF newF ≧ maxF |

| | |
|---|---|
| 8. | maxF ← newF, maxX ← x |

| | |
|---|---|
| 9. | END IF |

| | |
|---|---|
| 10. | END WHILE |

Given the experimental spectra at five time points and their monoisotopic peaks, the steps of the computer simulation optimization algorithm are implemented in two phases: Phase 1 processes data at Hr_{—}0 while Phase 2 processes the rest. In Phase 1, the concentration levels for all isotopologues of [0, 3], [1, 2], [2, 1] and [3, 0] are always 0, 0, 0 and 100%. Based on the monoisotopic peak, the peak width of Gaussian and Lorentzian are grouped with delta and optimized separately assuming there is only one curve constituting the whole peak. After obtaining the peak width of both curves, delta and fraction of Gaussian are grouped together and optimized. With all of the spectral parameters optimized, experiment parameters are optimized based on the complete experimental spectrum. The spectral parameters and derivative purity at Hr_{—}0 are saved for Phase 2. In Phase 2, firstly, the concentration levels are guessed via the saved parameters of Hr0; and then the guessed concentration levels are applied to estimate the spectral parameters following the steps in Phase 1; thirdly, estimate the experiment parameters to obtain the optimized concentration levels, which are to be used in the pathway modeling.

### IDAWG™ Pathway Modeling

IDWAG™ experiments follow the hexosamine biosynthetic pathway (an introduction can be found in Fantus et al. 2006, Ref 4). In order to synthesize (GalNAc)₁(Gal)₁(NeuAc)₂, three reactions involved in the biosynthetic pathway shown in FIG. 1 are listed in Equation 4 including the reactants, products and enzymes. For brevity, the enzymes are represented by EC number used in KEGG. The job of CMP- and UDP- is to transfer the glycan attached to it to another acceptor. For example, in the first reaction, UDP-Gal conveys Gal to (GalNAc)₁ so that (GalNAc)₁(Gal)₁ is produced.

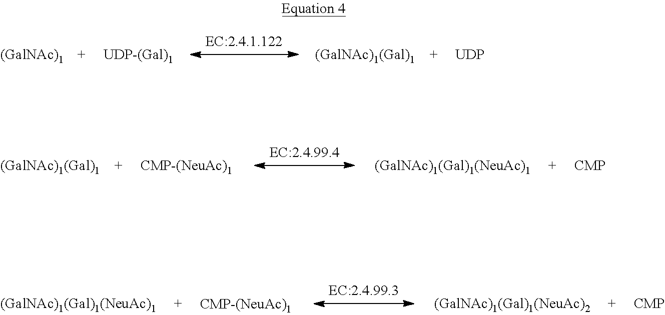

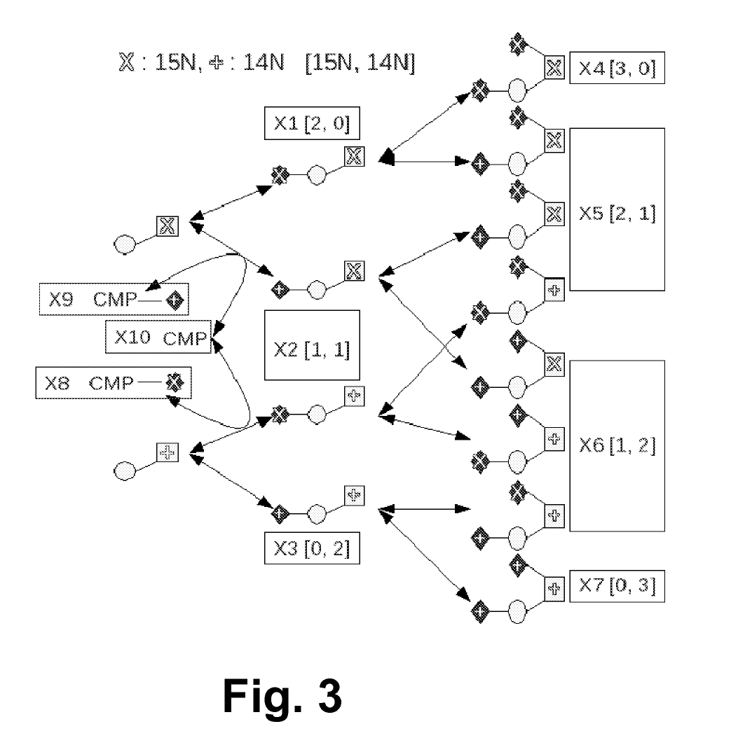

FIG. 3 shows the pathway model of three reactions synthesizing (GalNAc)₁(Gal)₁(NeuAc)₂. In the preliminary pathway model, the first two reactions in Equation 5 are not covered and the last reaction is discussed in detail for illustration purposes only. Because all of the reactions contain CMP-(NeuAc)₁ and CMP as reactant and product (in blue box), they are shown for how they are numbered and omitted from the other reactions with bidirectional arrows.

The pathway model starts with (GalNAc)₁(Gal)₁, ends with (GalNAc)₁(Gal)₁(NeuAc)₂ and the intermediate product is (GalNAc)₁(Gal)₁(NeuAc)₁. Due to the existence of both the heavy ¹⁵N and light ¹⁴N sources, the glycans containing nitrogen atoms, e.g., GalNAc and NeuAc will have different isotopologues for different positions where ¹⁴Nᵢ and ¹⁵Nⱼ are attached. Although different isotopomers exist for one isotopologue, they are identified as the same isotopologue in the mass spectrometer. For example (GalNAc)₁(Gal)₁(NeuAc)₂'s have four isotopologues. There is only one isotopomer for [0, 3] and [3, 0] since the three positions will be all ¹⁵N or all ¹⁴N, while [2, 1] and [1, 2] have three different isotopomers for each as indicated in FIG. 3.

The reactants and products that are going to be modeled are numbered as Xᵢ, i ∈ {1, . . . ,10}:
three isotopologues of (Gal)₁(GalNAc)₁(NeuNAc)₁: [2, 0] as X₁, [1, 1] as X₂ and [0, 2] as X₃;
four isotopologues of (Gal)₁(GalNAc)₁(NeuNAc)₂: [3, 0] as X₄, [2, 1] as X₅, [1, 2] as X₆ and [0, 3] as X₇;
two isotopologues of CMP-(NeuAc)₁: [1, 0] as X₈ and [0, 1] as X₉;
CMP is numbered as X₁₀.

Because of complexity and lack of data differentiating some of the isotopomers, the individual low level reactions were not modeled, but were aggregated into the meta-pathways.

After all the reactants and products are numbered, the reactions are grouped as follows:

X₁+X₈ [symbol] X₄+X₁₀ X₁+X₉ [symbol] X₅+X₁₀

X₂+X₈ [symbol] X₅+X₁₀ X₂+X₉ [symbol] X₆+X₁₀

X₃+X₈ [symbol] X₆+X₁₀ X₃+X₉ [symbol] X₇+X₁₀

At this stage, the effects of enzyme concentrations are not analyzed, so a pseudo reaction rate is essentially introduced to derive the following set of ordinary differential equations (ODEs) as listed in Equation 5.

\dot{X}₁=k_{[4→1]}[X₄][X₁₀]+k_{[5→1]}[X₅][X₁₀] \dot{X}₂=k_{[5→2]}[X₅][X₁₀]+k_{[6→2]}[X₆][X₁₀] \dot{X}₃=k_{[6→3]}[X₆][X₁₀]+k_{[7→3]}[X₇][X₁₀] \dot{X}₄=k_{[1→4]}[X₁][X₈] \dot{X}₅=k_{[1→5]}[X₁][X₉+k_{[2→5]}[X₂][X₈] \dot{X}₆=k_{[2→6]}[X₂][X₉]+k_{[3→6]}+k_{[3→6]}[X₃][X₈] \dot{X}₇=k_{[3→7]}[X₃][X₉] Equation 5

There are 12 constants (starting with k) as pseudo reaction rate and 7 variables Xᵢ, i ∈ {1,2, . . . , 7} as time derivative of concentration level. From the result of simulation optimization, the concentration level of isotopologues of (GalNAc)₁(Gal)₁(NeuAc)₁ and (GalNAc)₁(Gal)₁(NeuAc)₂ at five time points will be used as the initial values.

### IDAWG™ Pathway Modeling

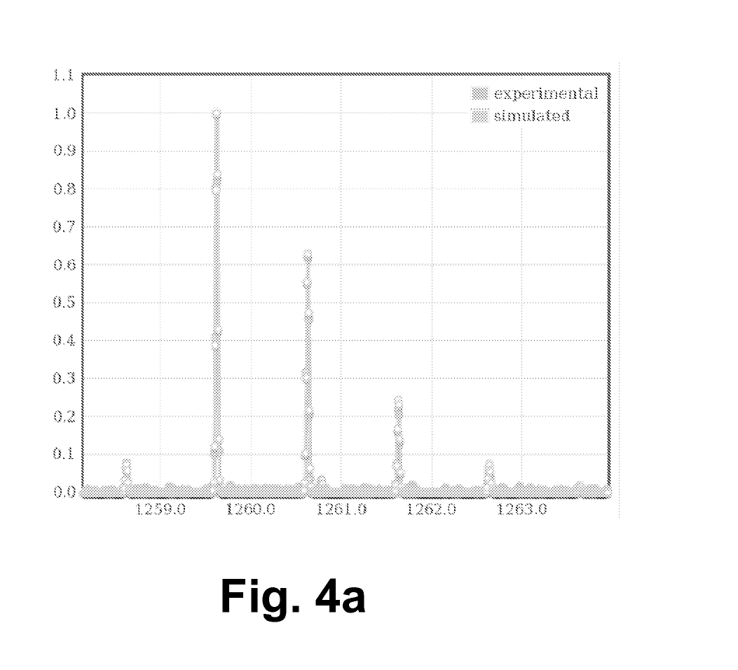

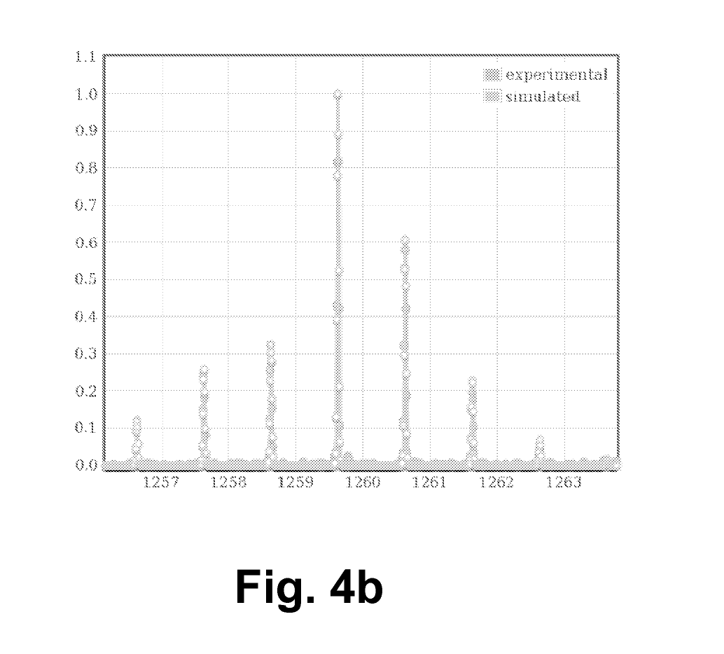

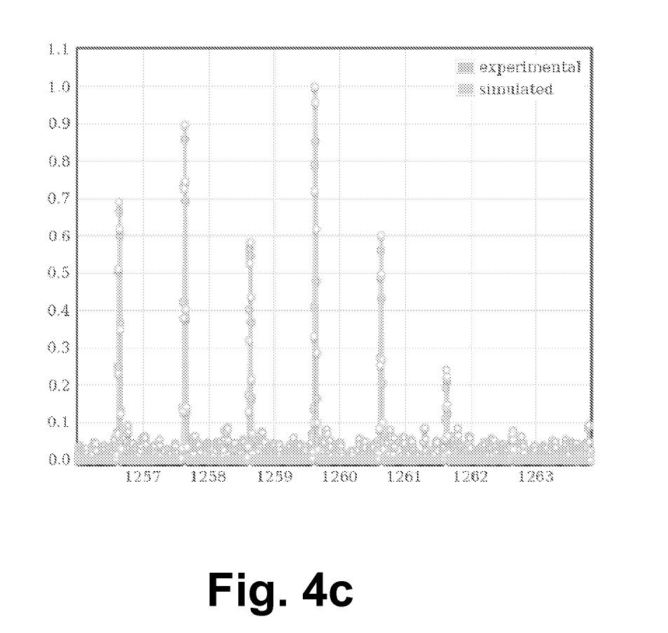

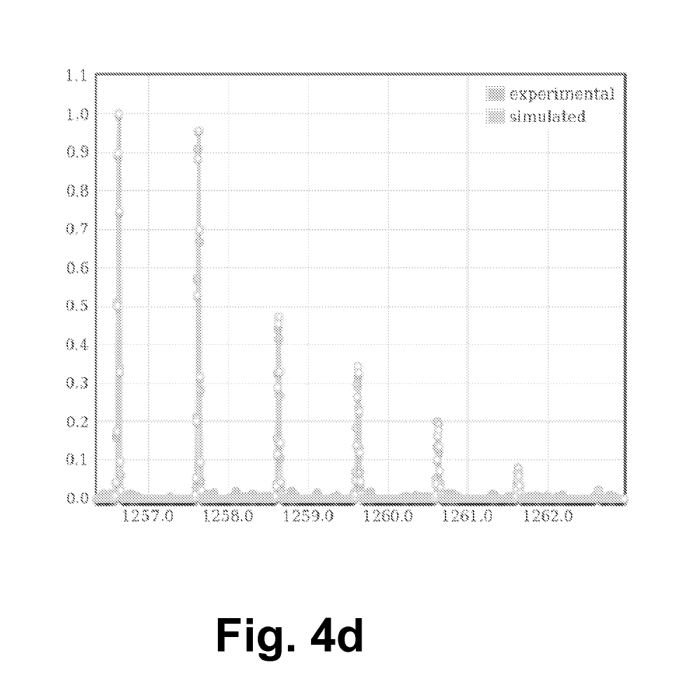

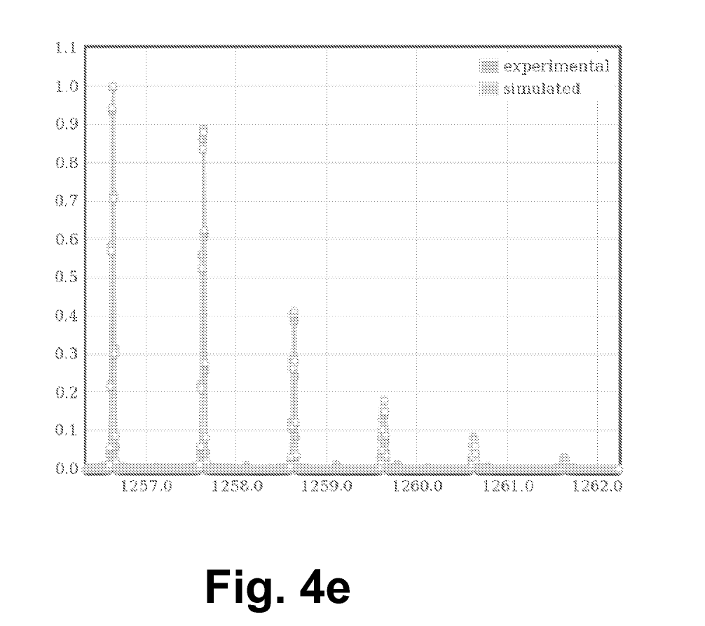

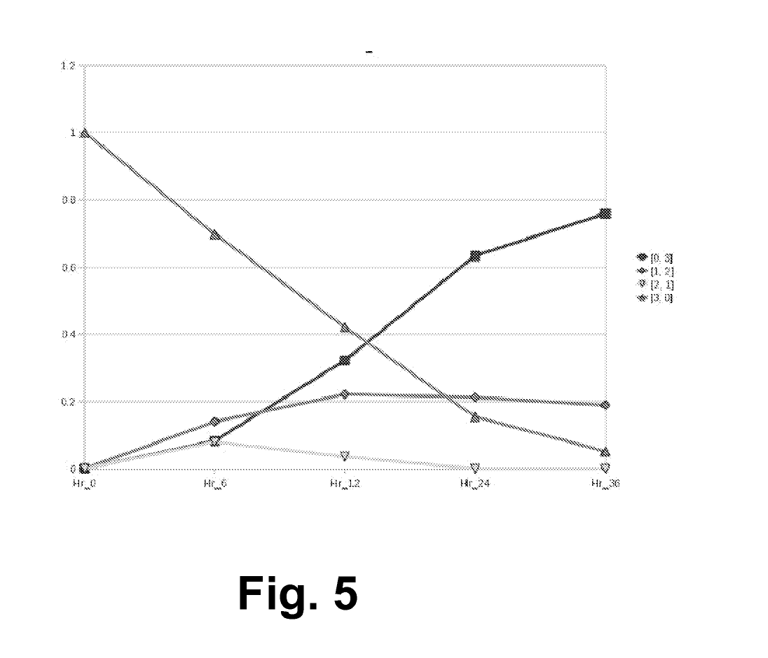

Based on the experimental spectrum of (NeuAc)₂(Gal)₁(GalNAc)₁ from the time points of Hr_{—}0, Hr_{—}6, Hr_{—}12, Hr_{—}24 and Hr_{—}36, the optimized simulated spectra are shown in FIG. 5. The optimized results for the coefficient of determination of simulated and experimental spectra are 0.9891, 0.9799, 0.9309, 0.9858 and 0.9919 for five time points, from which we can see that simulation algorithm can reach satisfactory results. Even with the existence of noise, as indicated in FIG. 4, the simulated spectrum fits the experimental spectrum well, which shows the robustness.

FIG. 5 shows the concentration levels of isotopologues of (NeuAc)₂(Gal)₁(GalNAc)₁ at five time points. It can be seen that the concentration level of each isotopologue changes over time. Although the available time points are limited, the time-series data can be used to model the isotopologues' behavior in the biosynthesis process, such as how a residue that contained ¹⁵N gets replaced by ¹⁴N and vice versa. Modeling biosynthesis pathway dynamics by looking into the reaction rates, concentration levels and other parameters that affect the biosynthesis pathways in IDAWG™ experiments will follow.

The [3, 0] curve rapidly drops over the 36 hr period. This has two causes: first more molecules with ¹⁴N are being synthesized, so the percentage of [3, 0] naturally drops. However, it seems to drop more than would be expected and this is possibly due to molecular remodeling (e.g. a reverse reaction followed by a forward reaction). Another interesting curve is [2, 1] which can be created as shown in FIG. 5 by either new biosynthesis or molecular remodeling. As more data is collected and the pathway modeling is refined, this question will be addressed.

In any event, the invention provides a computer system for simulating spectral patterns for isotope labeled glycans for use in a quantitative analysis of glycans which includes a database containing experimental spectral patterns of the isotope labeled glycans, a processor for identifying the elemental composition from the experimental spectrum patterns, calculating the number of labeled atoms from the elemental composition and generating a list of elemental compositions for all possible isotopologues, and for each isotopologue, calculating an array of [Probability, Mass] for the isotopologue, generating a simulated spectrum for each isotopic analog, based on a concentration level, and normalizing the simulated spectrum.

In yet another embodiment of the invention, a method for the isotope detection of aminosugars with glutamine and the quantitative analysis thereof comprises the steps of providing a computer system for simulating spectral patterns for isotope labeled glycans having a database containing experimental spectral patterns of the isotope labeled glycans, a processor for identifying the elemental composition from the experimental spectrum patterns, calculating the number of labeled atoms from the elemental composition and generating a list of elemental compositions for all possible isotopologues, and for each isotopic analog, calculating an array of [Probability, Mass] for the isotopic analog, and generating a simulated spectrum for each isotopic analog, based on a concentration level, and normalizing the simulated spectral pattern.

The method can also include obtaining a biological material and growing the biological material in the presence of isotope labeled glutamine, the biological material thereby producing labeled glycans, performing a spectral analysis of the labeled glycans and obtaining actual spectral patterns therefrom, and, comparing the actual spectral patterns to the simulated spectral patterns and extracting quantitative information that is encoded in the spectral patterns.

Cell surface complex carbohydrates play a critical role in cell recognition and adhesion, with carbohydrate-dependent interactions being essential for normal embryonic development and the function of the immune system. Carbohydrate modification has also been implicated in a number of different pathological conditions, including cancer. For example, human colon cancer is associated with antigenic and structural changes in mucin-type carbohydrate chains (O-glycans). Genetic diseases that affect the biosynthesis of protein O-glycans are also being found. Many patients with an unsolved defect in N-glycosylation have been found to have an abnormal O-glycosylation, with the defect not necessarily localized in one of the glycan-specific transferases, but can possibly be found in the biosynthesis of nucleotide sugars, their transport to the endoplasmic reticulum (ER)/Golgi, and in Golgi trafficking. In view of the number of genes involved in O-glycosylation processes and the increasing scientific interest in congenital disorders of glycosylation, it is expected that the number of identified diseases where tracking glycan biosynthesis can be used to develop treatments will likely grow rapidly in the future.

Understanding glycoprotein biosynthesis is important to many biological phenomena, and should eventually lead to the development of new drugs that will help to control pathological processes involving carbohydrate-mediated interactions.

### Related Work

In the area of simulation optimization, much research work has been done. Azadivar (1999) (Ref. 1) gave a tutorial on methods and techniques applied in the field of simulation optimization, e.g., gradient based search method, stochastic approximation methods, sample path optimization, response surface methods and heuristic search methods. Fu et al. (2005) (Ref 6) presented a survey of theoretical development in simulation optimization area and gave a list of available software and several illustrative applications. Kim (2006) (Ref 13) provided a review of two gradient-based techniques for simulation optimization (stochastic approximation and sample average approximation methods). Kleinstein et al. (2006) (Ref. 15) exploited how nonuniform sampling can help make the global optimization converge faster in the problem of parameter estimation in biological pathway.

In this work, a steepest gradient ascent algorithm of finite difference estimation is utilized, in which line search is used in controlling the step size for fast convergence and penalty function is applied to restrict the values of parameters when they violates the constraints. Because there are many ways to improve the performance and accuracy of gradient search, the gradient ascent algorithm may be modified to be faster and more robust. Because the success of gradient search depends on the shape of the surface, the feasibility of applying other meta-heuristic global optimization algorithms, such as Genetic Algorithm and Particle Swarm Optimization, will also be explored.

Systems biology approach, as introduced in (Kitano 2002), (Ref. 14) has been widely applied to model the biological systems and to gain insight into the interactions and operations within the system. Battogtokh et al. (2002) (Reference 2) proposed a chemical reaction network for qa gene cluster and developed an efficient Monte Carlo simulation method by randomly walking in the search space. (Rajasimha et al. 2004) (Ref. 20) modeled the effects of the cell divisions on the DNA drift and simulated activities such as mDNA replication and degradation, cell division and death. Funahashi et al. (2006) (Ref. 7) introduced CellDesigner, a process diagram editor for gene-regulatory and biochemical networks featuring graphical representation and integration of standardized technologies.

With regard to the approach utilized in simulation of systems biology, most previous work concentrated on building the logic model for the target biological system. Uhrmacher and Priami (2005) (Ref. 26) presented a discrete event systems specification in systems biology using π-Calculus and added another modeling formalism to support micro-macro modeling in cell biology in (Uhrmacher et al. 2007, Ref. 25). Mazemondet et al. (2009) (Ref. 18) investigated how to apply Imperative π-Calculus to model signaling pathway. Busi and Zandron (2006) (Ref. 3) applied Brane Calculi and Membrane Systems to model the behavior of a biological process, the LDL Cholesterol Degradation Pathway. However, due to lack of experimental data, the verification of the model remains a big challenge. Harris et al. (2009) (Ref. 9) extended the rule-based modeling language (BNGL) to enable explicit modeling of the compartmental organization of the cell and its effects on system dynamics. Instead of starting from formalism and then trying to verify the model, starting from the experimental data was used here, with parameters estimated via simulation of mass spectrum and then a meta-reaction model was built using system dynamics based on the optimized results.

Taking a closer look at the simulation of biosynthesis pathway, most of the previous work focused on modeling simple reactions. Sahle et al. (2006) (Ref. 23) presented COPASI, a new software tool for simulating and analyzing biochemical networks in the form of A+E [symbol] AE→B+E . Kwiatkowska et al. (2006) (Ref 16) aimed at biochemical reaction networks described in SBML, from which corresponding ODEs or discrete-state models are auto-generated and verified with probabilistic model checking However the chemical reactions involved in the present work is more complex because introduction of isotope (¹⁵N) brings complication in chemical reactions and how ¹⁵N will affect the system is unknown at the current stage. Therefore caution needs to be taken in simulating and analyzing such a biosynthetic pathway.

### Conclusions

Previously, due to lack of experimental data, the models proposed in the forms of the system dynamics or formalism were difficult to verify with the real data. Using the IDAWG™ technique, more information about isotopologues can be obtained from mass spectrometer via computer simulation, which will in turn help biologists look more closely into the quantification and analysis of biosynthetic pathway. The present invention thus provides: (i) a feasible and robust algorithm of simulating IDAWG™ mass spectrum, (ii) estimation of spectral and experiment parameters by searching for near-optimal solution including the isotopologues’ concentration levels which are difficult to obtain via biological methods, and (iii) provide a preliminary model of meta-reactions using system dynamics.

### REFERENCES

1) Azadivar, F. 1999. Simulation optimization methodologies. In WSC '99: Proceedings of the 31st conference on Winter simulation, pp 93-100: IEEE, Piscataway, N.J.

2) Battogtokh, D., D. K. Asch, M. E. Case, J. Arnold, and H.-B. Sch\ddot{}uttler. 2002. An ensemble method for identifying regulatory circuits with special reference to the qa gene cluster of neurospora crassa. Proc. Natl. Acad. Sci. 99 (26): pp 16904-16909.

3) Busi, N., and C. Zandron. 2006. Modeling and analysis of biological processes by mem(brane) calculi and systems. In WSC '06: Proceedings of the 38th conference on Winter simulation, pp 1646-1655: IEEE, Piscataway, N.J.

4) Fantus, I. G., H. J. Goldberg, C. I. Whiteside, and D. Topic. 2006. The diabetic kidney. Second ed., Chapter The Hexosamine Biosynthesis Pathway, pp 117-136. Contemporary Diabetes. Reading, Mass.: Humana Press.

5) Fletcher, R., and M. J. D. Powell. 1963. A rapidly convergent descent method for minimization. The Computer Journal 6 (2): pp 163-168.

6) Fu, M. C., F. W. Glover, and J. April. 2005. Simulation optimization: a review, new developments, and applications. In WSC '05: Proceedings of the 37th conference on Winter simulation, pp 83-95: IEEE, Piscataway, N.J.

7) Funahashi, A., Y. Matsuoka, A. Jouraku, H. Kitano, and N. Kikuchi. 2006. Celldesigner: a modeling tool for biochemical networks. In WSC '06: Proceedings of the 38th conference on Winter simulation, pp 1707-1712: IEEE, Piscataway, N.J.

8) Glish, G. L., and R. W. Vachet. 2003. The basics of mass spectrometry in the twenty-first century. Nature Reviews Drug Discovery 2 (2): pp 140-150.

9) Harris, L. A., J. S. Hogg, and J. R. Faeder. 2009. Compartmental rule-based modeling of biochemical systems. In WSC '09: Proceedings of the 41th conference on Winter simulation, pp 908-919: IEEE, Piscataway, N.J.

10) Heinrich, R., and S. Schuster. 1998. The modelling of metabolic systems. structure, control and optimality. Biosystems 47 (1-2): pp 61-77.

11) Hu, Q., R. J. Noll, H. Li, A. Makarov, M. Hardman, and R. Graham Cooks. 2005, April. The orbitrap: a new mass spectrometer. Journal of mass spectrometry: JMS 40 (4): pp 430-443.

12) Inczédy, J., T. Lengyel, and M. A. Ure. 1998. Compendium of analytical nomenclature definitive rules 1997. Available via http://old.iupac.org/publications/analytical_compendium/TOC_cha9.html[online 14 Aug. 2002].

13) Kim, S. 2006. Gradient-based simulation optimization. In WSC '06: Proceedings of the 38th conference on Winter simulation, pp 159-167: IEEE, Piscataway, N.J.

14) Kitano, H. 2002, March. Systems biology: A brief overview. Science 295 (5560): pp 1662-1664.

15) Kleinstein, S. H., D. Bottino, A. Georgieva, R. Sarangapani, and G. S. Lett. 2006. Nonuniform sampling for global optimization of kinetic rate constants in biological pathways. In WSC '06: Proceedings of the 38th conference on Winter simulation, pp 1611-1616: IEEE, Piscataway, N.J.

16) Kwiatkowska, M., G. Norman, D. Parker, O. Tymchyshyn, J. Heath, and E. Gaffney. 2006. Simulation and verification for computational modelling of signalling pathways. In WSC '06: Proceedings of the 38th conference on Winter simulation, pp 1666-1674: IEEE, Piscataway, N.J.

17) MacCoss, M. J., C. C. Wu, H. Liu, R. Sadygov, and J. R. Y. III. 2003. A correlation algorithm for the automated quantitative analysis of shotgun proteomics data. Analytical Chemistry 75 (24): pp 6912-6921.

18) Mazemondet, O., M. John, C. Maus, A. M. Uhrmacher, and A. Rolfs. 2009. Integrating diverse reaction types into stochastic models—a signaling pathway case study in the imperative pi-calculus. In WSC '09: Proceedings of the 41th conference on Winter simulation, pp 932-943: IEEE, Piscataway, N.J.

19) Orlando, R., J.-M. M. Lim, J. A. Atwood, P. M. Angel, M. Fang, K. Aoki, G. Alvarez-Manilla, K. W. Moremen, W. S. York, M. Tiemeyer, M. Pierce, S. Dalton, and L. Wells. 2009, May. IDAWG: Metabolic incorporation of stable isotope labels for quantitative glycomics of cultured cells. Journal of proteome research 8 (8): pp 3816-3823.

20) Rajasimha, H. K., D. C. Samuels, and R. E. Nance. 2004. A simulation methodology in modeling cell divisions with stochastic effects. In WSC '04: Proceedings of the 36th conference on Winter simulation, pp 2032-2038: IEEE, Piscataway, N.J.

21) Raman, R., S. Raguram, G. Venkataraman, J. C. Paulson, and R. Sasisekharan. 2005. Glycomics: an integrated systems approach to structure-function relationships of glycans. Nature Methods 2 (11): pp 817-824.

22) Reddy, V. N., M. L. Mavrovouniotis, and M. N. Liebman. 1993. Petri net representations in metabolic pathways. In Proceedings of the 1st International Conference on Intelligent Systems for Molecular Biology, pp 328-336: AAAI Press.

23) Sahle, S., R. Gauges, J. Pahle, N. Simus, U. Kummer, S. Hoops, C. Lee, M. Singhal, L. Xu, and P. Mendes. 2006. Simulation of biochemical networks using copasi: a complex pathway simulator. In WSC '06: Proceedings of the 38th conference on Winter simulation, pp 1698-1706: IEEE, Piscataway, N.J.

24) Silver, G. A., K. R. Bellipady, J. A. Miller, W. S. York, and K. J. Kochut. 2009. Supporting interoperability using the discrete-event modeling ontology (DeMO). In WSC '09: Proceedings of the 41th conference on Winter simulation, pp 1399-1410: IEEE, Piscataway, N.J.

25) Uhrmacher, A. M., R. Ewald, M. John, C. Maus, M. Jeschke, and S. Biermann. 2007. Combining micro and macro-modeling in devs for computational biology. In WSC '07: Proceedings of the 39th conference on Winter simulation, pp 871-880: IEEE, Piscataway, N.J.

26) Uhrmacher, A. M., and C. Priami. 2005. Discrete event systems specification in systems biology—a discussion of stochastic pi calculus and devs. In WSC '05: Proceedings of the 37th conference on Winter simulation, pp 317-326: IEEE, Piscataway, N.J.

27) Watson, T. J., and D. O. Sparkman. 2007. Introduction to mass spectrometry: Instrumentation, applications, and strategies for data interpretation. 4 ed., pp 1-862. Wiley.

1. A method for quantitatively tracking glycan biosynthesis comprising:
growing a target biological material in the presence of an isotope labeled glutamine, the biological material thereby producing labeled glycans;
preparing a plurality of parameterized spectral patterns of glycans using a computer simulation program by calculating simulated spectral signatures for every isotope analog thereof;
performing a spectral analysis of each isotope analog and obtaining actual spectral patterns therefrom;
comparing the actual spectral patterns to the simulated spectral patterns and adjusting the simulated spectra for improving the accuracy thereof;
using labeled glutamine and performing a biosynthesis to produce labeled glycans;
obtaining a sample and spectrally analyzing the sample at predetermined time intervals during the biosynthesis of the labeled glycans; and,
comparing the sample spectra to the computer simulated spectra and extracting quantitative data that is encoded in the spectral patterns of the sample spectra for each predetermined time interval.

2. The method of claim 1 wherein the data extracted includes the isotope composition of an ion cluster which generates the spectral pattern.

3. The method of claim 1 wherein the data extracted is a distribution of metabolic precursor pools from which the glycans, corresponding to an ion cluster which generates the spectral pattern, were synthesized.

4. The method of claim 1 wherein the computer simulation program calculates the simulated mass spectrum by:
identifying an elemental composition from an experimental spectrum calculating the number of labeling atoms from the elemental composition;
generating a list of elemental compositions for possible isotopologues; and, for each isotopologue,
calculating an array of [probability, Mass] for the isotopic analog,
simulating a mass spectrum of the isotopic analog,
normalizing the simulated spectrum,
parameterizing the spectra by dividing the simulation parameters into two sets, experimental parameters and spectral parameters, and,
optimizing the parameters in groups via a Gradient Ascent method.

5. The method of claim 1 further comprising providing a configuration file containing each residue composition and each corresponding monoisotopic mass in one-to-one mapping, wherein a residue/elemental composition is identified by looking up the monoisotopic mass (mass) in the configuration file,

6. The method of claim 5 further comprising calculating mass from both a charge state (z) and a value of the monoisotopic peak in the experimental spectrum via the formula m/z, wherein the monoisotopic peak corresponds to an isotopomer containing the most abundant isotopes for each element, and, using the monoisotopic peak to identify the elemental composition of each ion.

7. The method of claim 6 wherein the charge state (z) is an integer that indicates the electrical charge of the molecular ion.

8. The method of claim 5 wherein the configuration file contains the charge state stored therein.

9. The method of claim 5 further comprising computing the mass contributed to the isotopomer by a given element (eleMass) and a corresponding probability (probIso) via Equation (1):
$$probIso = p ( {x}_{1} , {x}_{2} , … , {x}_{k} ) = \frac{\prod {n}_{j} !}{\prod {x}_{i} !} \prod {p}_{i}^{{x}_{i}} \qquad Equation 1$$
where nⱼ is the number of atoms for each element j in the molecule such that Σxᵢ=Σnⱼ and xᵢ ∈ {0,1, . . . , n} is the number of atoms of each stable isotope in the isotopologue; mᵢ and pᵢ are obtained from the table of isotopes.

10. The method of claim 9 further comprising providing an array of [probIso, massEle] pairs calculated for each single element in each isotopomer's elemental composition, all of the elements being combined via a joint probability formula and computing an array of [Prob, Mass] pairs for every isotopomer, the array of [Prob, Mass] being used as theoretical probability and mass values and applied to simulate peaks of the spectral signature for each isotopologue:

11. The method of claim 1 wherein the experimental spectra is recorded using an orbital trapping method and post-processed using a Fast Fourier Transform (FFT) to provide spectral features having line shapes that are a combination of Lorentzian and Gaussian shapes.

12. The method of claim 11 wherein the parameters for optimization include a ratio of Gaussian to Lorentzian shapes, peak width, delta, and a normalization threshold.

13. The method of claim 10 further comprising using the array of [Prob, Mass] pairs for each isotopomer for generating simulated spectral peaks as a combination of Lorentzian and Gaussian shapes as calculated by the computer processor using the following Equation 2:
$${f}_{L} ( i ) = {\prod }_{j} {Prob}_{j} \times \frac{1}{πσ [ 1 + {[ \frac{{Mass}_{j} - ( {mass}_{i} + delta )}{σ} ]}^{2} ]} \\ {f}_{G} ( i ) = {\prod }_{j} {Prob}_{j} \times \frac{1}{σ \sqrt{2 π}} {exp}^{- \frac{{[ {Mass}_{j} - ( {mass}_{i} + delta ) ]}^{2}}{2 {σ}^{2}}} \qquad Equation 2$$
where σ is calculated from the peak width of the mixed Gaussian and Lorentzian curve, both Prob and Mass with index j are theoretical mass and probability values in [Prob, Mass] array of each isotopologue, mass with index i is calculated from charge state and m/z value from experimental spectrum.

14. The method of claim 13 wherein after both curves are simulated, a complete simulated spectrum for one isotopologue is computed via the following Equation 3:
simuSpecᵢ=r×f_{G}(i)+(1−r)×f_{L}(i) Equation 3
where simuSpec is an array of spectral data points with index i and r is the Gaussian fraction of the total.

15. The method of claim 14 wherein after generating a simulated spectral signature for every isotopologue, a complete simulated isotopic detection of aminosugars with glutamine mass spectrum is provided as a weighted sum of sub-spectral signature from all the (n+1) isotopologues based on the concentration level of each, if the number of nitrogen atoms in the elemental composition is n.

16. The method of claim 1 wherein the simulation parameters for optimization include experimental parameters selected from isotopic purity of 15N, and a relative abundances of the (n+1) isotopologues, and spectral parameters selected from peak widths of Gaussian and Lorentzian shapes, respectively, a fraction of the Gaussian shape relative to the total, delta and the normalization threshold.

17. The method of claim 16 wherein the parameters are grouped and optimized separately via a Gradient Ascent method.

18. A computer based system for performing the method of claim 1.

19. A computer system for simulating spectral patterns for isotope labeled glycans for use in a quantitative analysis of glycans comprising:
a database containing experimental spectral patterns of every isotope of each labeled glycan;
a processor for:
identifying the elemental composition from the experimental spectrum patterns;
calculating the number of labeled atoms from the elemental composition and generating a list of elemental compositions for all possible isotopologues, and for each isotopologue,
calculating an array of [probability, mass] for the isotopologue;
generating a simulated spectrum for each isotopologue, based on a concentration level,
normalizing the simulated spectrum, and
parameterizing the spectra by dividing the simulation parameters into two sets, experimental parameters and spectral parameters, and, optimizing the parameters in groups.

20. The computer system of claim 19 wherein the computer processor optimizes the parameters in groups via a Gradient Ascent method.

21. The computer system of claim 19 further comprising a configuration file for containing each residue composition and each corresponding monoisotopic mass in one-to-one mapping, wherein a residue/elemental composition is identified by looking up the monoisotopic mass (mass) in the configuration file,

22. The computer system of claim 21 wherein the processor calculates mass from both a charge state (z) and a value of the monoisotopic peak in the experimental spectrum via the formula m/z, wherein the monoisotopic peak corresponds to an isotopomer containing the most abundant isotopes for each element, and, the processor using the monoisotopic peak to identify the elemental composition of each ion.

23-33. (canceled)

34. A method for the periodic isotope detection of aminosugars with glutamine and the quantitative analysis of the biosynthesis thereof comprising the steps of:
providing a computer system for simulating spectral patterns for isotope labeled glycans, the computer system having a database containing experimental spectral patterns of the isotope labeled glycans, and a processor for identifying the elemental composition from the experimental spectrum patterns, calculating the number of labeled atoms from the elemental composition and generating a list of elemental compositions for all possible isotopologues, and for each isotopologue, calculating an array of [mass, probability] for the isotopologue, generating a simulated spectrum for each isotopic analog, based on a concentration level, normalizing the simulated spectra, the computer system parameterizing the simulated spectrum by dividing the simulation parameters into two sets, experimental parameters and spectral parameters, optimizing the parameters in groups, and confirming the quantitative information that is encoded in the simulated spectral patterns;
obtaining a biological material and growing the biological material in the presence of isotope labeled glutamine, the biological material thereby producing labeled glycans in a biosynthesis,
performing periodic sampling during the biosynthesis of labeled glycans and performing a spectral analysis of the sampled labeled glycans for obtaining actual spectral patterns therefrom, and,
comparing the actual spectral patterns to the simulated spectral patterns and extracting quantitative information that is encoded in the spectral patterns for tracking the biosynthesis of the produced labeled glycans over time.

35-36. (canceled)

37. The method of claim 34 wherein the computer simulation program calculates the simulated mass spectrum by:
identifying an elemental composition from an experimental spectrum;
calculating the number of labeling atoms from the elemental composition;
generating a list of elemental compositions for possible isotopologues; and,
for each isotopologue,
calculating an array of [probability, Mass] for the isotopic analog,
simulating a mass spectrum of the isotopic analog,
normalizing the simulated spectrum,
parameterizing the spectra by dividing the simulation parameters into two sets, experimental parameters and spectral parameters, and,
optimizing the parameters in groups via a Gradient Ascent method.

38. The method of claim 34 further comprising providing a configuration file containing each residue composition and each corresponding monoisotopic mass in one-to-one mapping, wherein a residue/elemental composition is identified by looking up the monoisotopic mass (mass) in the configuration file,

39-50. (canceled)
